(19) United States
(12) Patent Application Publication
(10) Pub. No.: US 2026/0188712 A1
(43) Pub. Date: Jul. 2, 2026

(54) METHOD FOR OPERATING A FUEL CELL SYSTEM, AND FUEL CELL SYSTEM

(71) Applicant: Robert Bosch GmbH, Stuttgart (DE)

(72) Inventors: Simon Buehler, Stuttgart (DE); Timo Bosch, Renningen (DE); Tobias Falkenau, Esslingen (DE)

(21) Appl. No.: 19/129,752

(22) PCT Filed: Oct. 30, 2023
(86) PCT No.: PCT/EP2023/080217

§ 371 Date: May 14, 2025

(30) Foreign Application Priority Data
Nov. 15, 2022 (DE) 10 2022 212 143.0

(51) Int. Cl. H01M 8/0444; H01M 8/04089; H01M 8/04746

(52) U.S. Cl. CPC H01M 8/04447; H01M 8/04097; H01M 8/04761

(57) ABSTRACT

The invention relates to a method for operating a fuel cell system (BS), having the steps of determining (S1) a gas concentration of a hydrogen and/or a concentration of a foreign gas in a gaseous fuel on an anode side (A) of a fuel cell (BZ) while operating a fuel cell (BZ); comparing (S2) the gas concentration of the hydrogen to a specified hydrogen concentration value and/or comparing the concentration of the foreign gas to a specified foreign gas concentration value; opening (S3) a discharge valve (AV) in a recirculation circuit (RZ), wherein the recirculation circuit (RZ) is connected to the anode side (A) and the gaseous fuel is at least partially discharged out of the recirculation circuit (RZ) via the discharge valve (AV) when the gas concentration of the hydrogen falls below the specified hydrogen concentration value and/or when the concentration of the foreign gas exceeds the specified foreign gas concentration value; introducing (S4) fresh hydrogen from a hydrogen supply line (WL) into the recirculation circuit (RZ), wherein the hydrogen supply line (WL) is connected to the recirculation circuit (RZ); monitoring (S5) an opening time of the discharge valve (AV) and comparing the opening time to a target time; and reducing (S6) an operating output of the fuel cell (BZ) by a specified degree over a specified time when the opening time exceeds the target time.

### BACKGROUND

The present invention relates to a method for operating a fuel cell system and a fuel cell system.

In a fuel cell system, in the anode circuit, the hydrogen is fed from the medium pressure range of the fuel cell. A control valve for the as-needed dosing of the hydrogen and a blower apparatus are typically used. With a recirculation blower, hereinafter called ARB (Anode Recirculation Blower), the unconsumed hydrogen in the fuel cell system can be recirculated from the outlet of the fuel cell (stack) back into the inlet. This return flow can be part of the anode subsystem, which can typically include an upstream water separator. Because the upstream water separator is typically not able to completely separate the process water, ARBs that may have an integrated water separator are employed.

Polymer electrolyte membrane (PEM) fuel cell systems convert hydrogen by means of oxygen into electrical energy, generating waste heat and water. The conversion of hydrogen means here that hydrogen molecules are consumed or removed on the anode side and that air and oxygen can be converted into power, water, and heat at the polymer electrolyte membrane.

A fuel cell may comprise an anode supplied with hydrogen, a cathode supplied with air, and a polymer electrolyte membrane placed between the two. Advantageously, a plurality of such individual fuel cells can be stacked in order to increase the generated electric voltage, wherein supply channels can be located inside this stack, which provide hydrogen and air to the individual cells and can discharge a depleted wet air as well as the depleted anode exhaust.

Recirculation can typically be achieved by means of the recirculation blower or passively by means of the jet pump, and a separation of liquid water and gaseous portions of the anode exhaust gas can be achieved with the application of water separators, wherein the water separator can also store a certain volume of the waste water. After reaching a certain limit, water can be discharged by opening a so-called discharge valve, which typically occurs at the outlet of the anode.

One measure of recirculation is the ratio between a hydrogen that is supplied to the fuel cell and the hydrogen that is consumed by the electrochemical reaction, wherein this ratio is commonly referred to as lambda and can correspond to the relation,

$${λ}_{{H}_{2}} = \frac{{\dot{m}}_{{H}_{2} , Stack in}}{{\dot{m}}_{{H}_{2} , Stack consumed}}$$

wherein a temporal change of the mass of the hydrogen applied at the anode can be divided by the temporal change of the mass of the hydrogen consumed at the anode.

The aforementioned lambda is an essential characteristic for the fuel cell, wherein a sufficiently high lambda and thus a hydrogen concentration can be present at the anode inlet, so that the catalyst in the stack of the fuel cell can be supplied with a targeted amount of H2 over the entire flow range.

Furthermore, via diffusion processes, a foreign gas, for example nitrogen, can also enter the anode range, wherein however the freshly supplied fuel can also contain a certain proportion of this foreign gas. Nitrogen represents an inert gas for the fuel cell, which can reduce cell voltage and thus the voltage on the stack. For this reason, it is desirable to be able to repeatedly also discharge gas from the anode space during a driving cycle in order to be able to reduce the foreign gas content, which can be done with a so-called purge valve (discharge valve). Fresh hydrogen can be supplied by means of hydrogen metering valves, which can be configured as proportional valves. The control strategy provides that this valve be used in order to regulate the gas pressure within an anode path, measured by means of a pressure sensor at a defined position, up to a defined target pressure as a function of the operating point. Typically, such valves or a combined valve required for discharging foreign gas/nitrogen and water are mounted in an apparatus of the recirculation path.

By opening the discharge valve, a nitrogen concentration can be lowered, and thus the lambda can also be increased again. The derivation can be carried out on a pre-controlled basis as a function of the operating point or it can carried out on the basis of a hydrogen concentration determination, as needed.

In DE 10 2020 212 178 A1, an operation of a fuel cell is described.

### SUMMARY

The present invention provides a method for operating a fuel cell system according to the disclosure.

The underlying idea of the present invention is to specify a method for operating a fuel cell system and a fuel cell system, for example for a vehicle, wherein supplying fuel to the fuel cell, which is required in order to impart an associated output of the fuel cell, can be improved.

Advantageously, a high level of foreign gas or nitrogen can be better detected in order to limit the output of the fuel cell system as needed, so that the need for an emergency shutdown can be at least reduced. A corresponding indication can be given to the driver so that, if necessary, he or she can complain about the fuel in the tank and have it replaced. In this way, customer satisfaction can be increased, and the availability of the fuel cell system can be increased.

According to the invention, the method for operating a fuel cell system consists of determining a gas concentration of a hydrogen and/or a concentration of a foreign gas in a gaseous fuel on an anode side of a fuel cell while operating a fuel cell; comparing the gas concentration of the hydrogen to a specified hydrogen concentration value and/or comparing the concentration of the foreign gas to a specified foreign gas concentration value; opening a discharge valve in a recirculation circuit, wherein the recirculation circuit is connected to the anode side and the gaseous fuel is at least partially discharged out of the recirculation circuit via the discharge valve when the gas concentration of the hydrogen falls below the specified hydrogen concentration value and/or when the concentration of the foreign gas exceeds the specified foreign gas concentration value; introducing fresh hydrogen from a hydrogen supply line into the recirculation circuit, wherein the hydrogen supply line is connected to the recirculation circuit; monitoring an opening time of the discharge valve and comparing the opening time to a target time; and reducing an operating output of the fuel cell by a specified degree over a specified time when the opening time exceeds the target time.

For a desired mode of operation, under which particular operating parameters, such as the power of the fuel cell, can occupy an expected magnitude, an associated operating point may be known and, under this operating point, the operating conditions necessary for this purpose may be known for the present type of fuel cell, for example, which specified hydrogen concentration value should at least be present and/or which specified foreign gas concentration value may at most be present.

The opening time of the discharge valve, with which the hydrogen and/or the foreign gas can be discharged, can advantageously serve to regulate the gas concentration of the hydrogen remaining in the gaseous fuel of the recirculation path and/or the concentration of the foreign gas. The gas concentration of the hydrogen and/or the concentration of the foreign gas can be determined at specified locations of the recirculation circuit and the opening time can be adjusted in order to meet or approximate the concentration targets of the hydrogen and/or the foreign gas. Likewise, a supply line of the fresh hydrogen can be adapted to the determined gas concentration of the hydrogen and/or the concentration of the foreign gas in order to meet or approximate the concentration targets of the hydrogen and/or the foreign gas and, in both adjustment cases, if necessary, reduce the output of the fuel cell and/or the propulsion of the vehicle, so that the decreased output can function with a lower gas concentration of the hydrogen and/or a higher concentration of the foreign gas with a minimum operation.

The steps of determining the gas concentrations, performing a comparison, opening the discharge valve, and closing it when the gas concentrations again meet specifications, as well as reducing an operating performance can occur sequentially in a control loop and can be repeated during operation of the fuel cell.

According to a preferred embodiment of the method, the foreign gas is nitrogen.

According to a preferred embodiment of the method, the specific degree of reduction in the operating output of the fuel cell is determined as a function of an amount of a deviation between the opening time of the discharge valve and the target time.

The greater the amount of deviation, the greater the reduction can be.

According to a preferred embodiment of the method, the operating output of the fuel cell is increased again after the specified time, when the opening time again falls below the target time.

According to a preferred embodiment of the method, the specified degree of reduction in the operating output of the fuel cell is adjusted according to a gradient of the deviation.

The reduction in power can be continuous with a gradient of 5-50 kW/s until the next test step occurs, or incrementally in 1-10 kW steps until the next test step occurs.

According to a preferred embodiment of the method, the reduction of the operating output of the fuel cell is indicated to a user of the fuel cell system, and information about a quality of the gaseous fuel and/or the fresh hydrogen is thereby provided.

According to a preferred embodiment of the method, the specified hydrogen concentration value and/or the target time is determined as a function of the operating point for a specified operation of the fuel cell.

There can be an optimal hydrogen concentration content that can be advantageously maintained, e.g. 60-100 vol % H2 (hydrogen).

If the value deviates below a threshold of 80-60% over a period of 1-100 s, the output should be reduced.

According to a preferred embodiment of the method, a minimum operation of the fuel cell is maintained during the reduction.

The minimum operation can be a predetermined minimum operation.

According to the invention, the fuel cell system comprises a fuel cell having a cathode side and an anode side; a recirculation circuit connected to the anode side and a discharge valve in the recirculation circuit via which the gaseous fuel can be at least partially discharged from the recirculation circuit; a hydrogen supply line connected to the recirculation circuit via which fresh hydrogen can be fed into the recirculation circuit; a sensor device arranged on the anode side and/or in the recirculation circuit, with which a gas concentration of a hydrogen and/or a concentration of a foreign gas can be determined in the gaseous fuel on an anode side and/or in the recirculation circuit; and a control device connected to the sensor device, the fuel cell, and the discharge valve and configured so as to carry out a method according to the invention.

According to a preferred embodiment of the fuel cell system, the discharge valve is arranged in the direction of flow of the gaseous fuel in the recirculation circuit between the anode side and the hydrogen supply line.

The fuel cell system can also be characterized by the features mentioned in connection with the method and by the advantages of the method, and vice versa.

Further features and advantages of embodiments of the invention are apparent from the following description with reference to the accompanying drawings.

### BRIEF DESCRIPTION OF THE DRAWINGS

The present invention is explained in greater detail below with reference to the exemplary embodiments indicated in the figures of the drawing.

### Shown are:

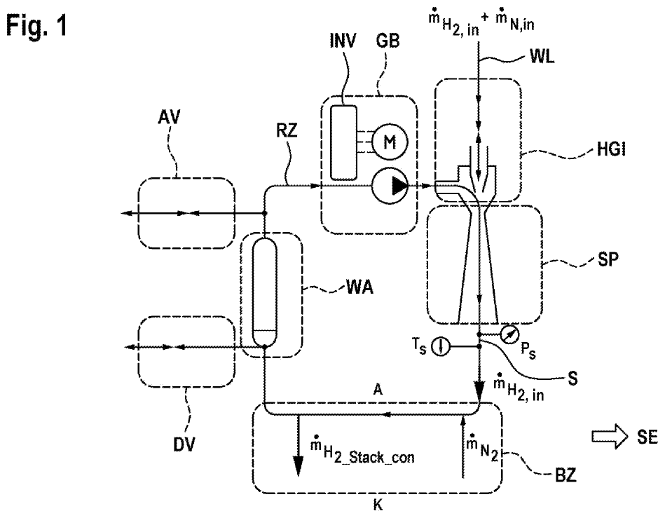

FIG. 1 a schematic representation of a fuel cell system according to one exemplary embodiment of the present invention;

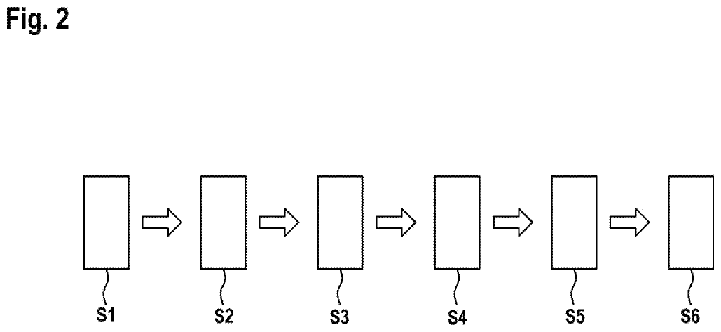

FIG. 2 a block diagram of method steps of the method for operating a fuel cell system according to one exemplary embodiment of the present invention.

Identical reference signs in the figures denote identical or functionally identical elements.

### DETAILED DESCRIPTION

FIG. 1 shows a schematic representation of a fuel cell system according to one exemplary embodiment of the present invention.

The fuel cell system BS comprises a fuel cell BZ having a cathode side K and an anode side A; a recirculation circuit RZ connected to the anode side A and a discharge valve AV in the recirculation circuit RZ via which the gaseous fuel can be at least partially discharged from the recirculation circuit RZ; a hydrogen supply line WL connected to the recirculation circuit RZ via which fresh hydrogen can be fed into the recirculation circuit RZ; a sensor device arranged on the anode side A and/or in the recirculation circuit RZ, with which a gas concentration of a hydrogen and/or a concentration of a foreign gas can be determined in the gaseous fuel on an anode side A and/or in the recirculation circuit RZ; and a control device SE connected to the sensor device, the fuel cell, and the discharge valve AV and configured so as to carry out a method according to the invention. The discharge valve AV can be arranged in the direction of flow of the gaseous fuel in the recirculation circuit RZ between the anode side A and the hydrogen supply line WL.

A water separator WA can be arranged in the recirculation circuit RZ and can separate the accumulating moisture in the gaseous fuel and store it in an internal tank, wherein this process water can then be discharged via a water discharge valve DV. The discharge valve AV can be arranged in the direction of flow of the recirculation circuit RZ before or after the water separator WA. In the recirculation circuit RZ, there can also be a blower apparatus GB with an electric motor M for the blower and its inverter INV and a hydrogen injection unit HGI, which can be connected to the hydrogen supply line WL and can be connected to a suction jet pump SP in the recirculation circuit RZ.

In the fuel cell system shown, the sensor device S, which can be arranged, for example, on the recirculation circuit RZ between the HGI and the anode A, can measure and transmit the pressure and the temperature to the control device SE, which can then control the supply of the hydrogen and/or the output of the fuel cell BZ and/or the opening time of the valves DV and/or AV. The sensor device S and control device SE can serve as an apparatus for determining the concentration of the gaseous fuel on the anode side, whereby the hydrogen concentration necessary for the operating point can be adjusted by activating the discharge valve AV as needed.

By opening the discharge valve AV, the nitrogen/hydrogen mixture can advantageously be omitted from the recirculation circuit RZ and from the anode side A, and the concentration of hydrogen can be increased by supplying fresh hydrogen. In the event that a poor-quality fuel is supplied that does not satisfy a specified requirement for the desired function of the fuel cell, more nitrogen can typically accumulate in the anode, whereby a necessary open time of the discharge valve AV can increase through the concentration control. It can also be the case that the corresponding control limit is reached for particularly poor-quality fuels, for example when the valve is permanently open or the maximum open duration is reached, for example when the discharged gas cannot otherwise be sufficiently diluted. In this case, the hydrogen concentration in the anode may decrease, so that there can be an increasing control deviation in the hydrogen concentration regulation. If a specified threshold value for the opening time is exceeded, the system according to the invention can reduce the output until the target value of the hydrogen concentration can be achieved again.

A switching off can advantageously be at least shortened or even avoided, as would occur without the method according to the invention. In the event that the corresponding output reduction is performed over an extended period of time, an additional notification can be displayed to the driver indicating poor-quality fuel and a resulting output limit of the fuel cell system.

A previously determined limit dependent on the operating point for the maximum opening time of the discharge valve AV can also be defined, instead of or in addition to a control deviation. If the control device as the controller requires correspondingly longer opening durations, this can be an indication of poor-quality fuel, and corresponding feedback can be given to the driver. With this variant, poor-quality fuel can also be detected outside of a full-load point.

In order to be able to achieve an accuracy of the above-mentioned control method, variable effects over service life, such as service life-based valve flow and/or nitrogen transfer (crossover) via the membrane of the fuel cell, which may be known for this type of fuel cell, can be considered. Information about an output reduction or also an increase by improving the supply situation can be provided to other subsystems, e.g. the control device of the entire vehicle.

The concentration determinations can also be carried out on the blower apparatus GB with corresponding sensors, for example. To regulate output, the corresponding parameters on the fuel cell BZ, such as the output current, can be controlled. To determine the corresponding lambda the consumed mass flow 2_tack_con at the anode side A of the fuel cell BZ can be determined and compared to the supplied mass flow of the hydrogen 2,n. The feed mass flow of the hydrogen and the nitrogen can be determined from the supply line WL.

FIG. 2 shows a block diagram of method steps of the method for operating a fuel cell system according to one exemplary embodiment of the present invention.

The method consists of determining S1 a gas concentration of a hydrogen and/or a concentration of a foreign gas in a gaseous fuel on an anode side of a fuel cell while operating a fuel cell; comparing S2 the gas concentration of the hydrogen to a specified hydrogen concentration value and/or comparing the concentration of the foreign gas to a specified foreign gas concentration value; opening S3 a discharge valve in a recirculation circuit, wherein the recirculation circuit is connected to the anode side and the gaseous fuel is at least partially discharged out of the recirculation circuit via the discharge valve when the gas concentration of the hydrogen falls below the specified hydrogen concentration value and/or when the concentration of the foreign gas exceeds the specified foreign gas concentration value; introducing S4 fresh hydrogen from a hydrogen supply line into the recirculation circuit, wherein the hydrogen supply line is connected to the recirculation circuit; monitoring S5 an opening time of the discharge valve and comparing the opening time to a target time; and reducing S6 an operating output of the fuel cell by a specified degree over a specified time when the opening time exceeds the target time.

Although the present invention has been described in full with reference to the preferred embodiment, it is not limited thereto and can be modified in many ways.

1. A method for operating a fuel cell system (BS), comprising the following steps:
determining (S1) a gas concentration of a hydrogen and/or a concentration of a foreign gas in a gaseous fuel on an anode side (A) of a fuel cell (BZ) while operating a fuel cell (BZ);
comparing (S2) the gas concentration of the hydrogen to a specified hydrogen concentration value and/or comparing the concentration of the foreign gas to a specified foreign gas concentration value;
opening (S3) a discharge valve (AV) in a recirculation circuit (RZ), wherein the recirculation circuit (RZ) is connected to the anode side (A) and the gaseous fuel is at least partially discharged out of the recirculation circuit (RZ) via the discharge valve (AV) when the gas concentration of the hydrogen falls below the specified hydrogen concentration value and/or when the concentration of the foreign gas exceeds the specified foreign gas concentration value;
introducing (S4) fresh hydrogen from a hydrogen supply line (WL) into the recirculation circuit (RZ), wherein the hydrogen supply line (WL) is connected to the recirculation circuit (RZ);
monitoring (S5) an opening time of the discharge valve (AV) and comparing the opening time to a target time;
and reducing (S6) an operating output of the fuel cell (BZ) by a specified degree over a specified time when the opening time exceeds the target time.

2. The method according to claim 1, in which the foreign gas is nitrogen.

3. The method according to claim 1, in which the specific degree of reduction in the operating output of the fuel cell (BZ) is determined as a function of an amount of a deviation between the opening time of the discharge valve (AV) and the target time.

4. The method according to claim 1, in which the operating output of the fuel cell (BZ) is increased again after the specified time, when the opening time again falls below the target time.

5. The method according to claim 3, in which the specified degree of reduction in the operating output of the fuel cell (BZ) is adjusted according to a gradient of the deviation.

6. The method according to claim 1, in which the reduction of the operating output of the fuel cell (BZ) is indicated to a user of the fuel cell system (BS), and information about a quality of the gaseous fuel and/or the fresh hydrogen is thereby provided.

7. The method according to claim 1, in which the specified hydrogen concentration value and/or the target time is determined as a function of the operating point for a specified operation of the fuel cell (BZ).

8. The method according to claim 1, in which a minimum operation of the fuel cell (BZ) is maintained during the step of reduction.

9. A fuel cell system (BS) comprising
a fuel cell (BZ) having a cathode side and an anode side (A);
a recirculation circuit (RZ) connected to the anode side (A) and a discharge valve (AV) in the recirculation circuit (RZ) via which the gaseous fuel can be at least partially discharged from the recirculation circuit (RZ);
a hydrogen supply line (WL) connected to the recirculation circuit (RZ) via which fresh hydrogen can be fed into the recirculation circuit (RZ);
a sensor device arranged on the anode side (A) and/or in the recirculation circuit (RZ), with which a gas concentration of a hydrogen and/or a concentration of a foreign gas can be determined in the gaseous fuel on an anode side (A) and/or in the recirculation circuit (RZ); and
a control device (SE) connected to the sensor device, the fuel cell, and the discharge valve (AV) and configured so as to carry out a method according to claim 1.

10. The fuel cell system (BS) according to claim 9, in which the discharge valve (AV) is arranged in the direction of flow of the gaseous fuel in the recirculation circuit (RZ) between the anode side (A) and the hydrogen supply line (WL).
